(19) United States
(12) Patent Application Publication
(10) Pub. No.: US 2010/0270908 A1
(43) Pub. Date: Oct. 28, 2010

(54) FLUORESCENT LAMP COMPATIBLE LED ILLUMINATING DEVICE

(75) Inventor: Fumio Suzuki, Kyoto-shi (JP)

Correspondence Address: ALLEMAN HALL MCCOY RUSSELL & TUTTLE LLP, 806 SW BROADWAY, SUITE 600, PORTLAND, OR, 97205-3335, US

(73) Assignee: ABEL SYSTEMS INCORPORATION, Kyoto-shi, Kyoto (JP)

(21) Appl. No.: 12/666,639

(22) PCT Filed: Jul. 9, 2007
(86) PCT No.: PCT/JP2007/063692

§ 371 Date: Dec. 23, 2009

(30) Foreign Application Priority Data
Jun. 27, 2007 (JP) 2007-169268

(51) Int. Cl. H01J 1/62

(52) U.S. Cl. 313/483

(57) ABSTRACT

A fluorescent lamp compatible LED illuminating device (1) comprises a glass fluorescent pipe (2) used for a fluorescent lamp, an LED (3) for emitting deep ultraviolet light, a light scattering member (5) that is housed or arranged in the fluorescent pipe (2) and that diffuses or scatters the light from the LED (3), and a reconversion circuit (4) that is mounted on the fluorescent pipe (2) and that reconverts an output from an electric circuit (A1) inherent to the fluorescent lamp such as a stabilizer, a glow switch starter and an inverter and supplies the reconverted output to the LED (3). A surface electrode (32) is provided on the surface of the LED (3). A plurality of through bores (321) are formed intermittently over the surface electrode (32). A dielectric antenna (36) for collecting and transmitting the deep ultraviolet light or the ultraviolet light is provided in the through bore (321). The fluorescent lamp compatible LED illuminating device (1) is not inferior to a conventional fluorescent lamp in terms of the total amount of light and illuminance, and is highly efficient.

### FIELD OF THE ART

This invention relates to a fluorescent lamp compatible LED illuminating device that can replace an existing fluorescent pipe using an LED as a light source.

### BACKGROUND ART

A fluorescent lamp emits visible light outside of a fluorescent pipe via fluorescence, wherein ultraviolet light generated by a collision between gaseous mercury enclosed inside of a fluorescent glass pipe and an electron emitted from a fluorescent pipe filament is absorbed by a fluorescent material applied to an inside of the fluorescent glass pipe, causing the fluorescent material to emit visible light. Since the fluorescent lamp has a characteristic of consuming less electric power than an incandescent lamp at the same luminance and producing a small heat release value, the fluorescent lamp is mass-produced and widely used generally in Japan.

Meanwhile, development of LEDs is progressing recently such that a high power LED also was developed in addition to the LED that emits blue light or ultraviolet light. Thus applications of LEDs are expanding not only to include conventional indicators but also to include general illuminating devices. (refer to patent documents 1, 2)

The LED has a longer operating life and its light intensity is more stable if compared with the fluorescent lamp, and there is no problem of requiring time for starting-up the LED and of discarding the LED. In view of a total light intensity or an illumination intensity, however, the LED is still behind the fluorescent light. Although the LED is high-powered so that a light intensity per unit illuminating area is increasing, a lot of LEDs are required in order to obtain a light intensity comparable to the fluorescent light in total. In addition, a heat release value also gets very big so that a heat dissipating member becomes necessary as shown in the patent documents 1 and 2.

Patent document 1: Japan patent laid-open number 2005-166578
Patent document 2: Japan patent laid-open number 2007-109504

### DISCLOSURE OF THE INVENTION

### Problems to be Solved by the Invention

The present claimed invention intends to eliminate a deficit of the LED so as to largely advance an availability of the LED to a general illumination device and a main object of this invention is to provide a fluorescent lamp compatible LED illuminating device that can utilize the fluorescent light that has been commercially available and broadly standardized as it is.

### Means to Solve the Problems

More specifically, the fluorescent lamp compatible LED illuminating device comprises the following (1)˜(4). (1) a fluorescent pipe used for a fluorescent lamp, (2) an LED comprising a semiconductor element body that emits deep ultraviolet light or ultraviolet light from a luminous layer in a shape of a thin plate formed midway in a thickness direction, a surface electrode arranged on a surface of the semiconductor element body, and dielectric antennas each of which is arranged respectively in a plurality of through bores intermittently formed over the surface electrode and penetrates a thickness direction of the surface electrode and each of which collects and transmits the deep ultraviolet light or the ultraviolet light emitted from the semiconductor element body, and each of which is mounted on the fluorescent pipe so as to irradiate the deep ultraviolet light or the ultraviolet light toward an internal space of the glass fluorescent pipe, (3) a light scattering member that is housed or arranged in the fluorescent pipe and that diffuses or scatters the light from the LED, and (4) a reconversion circuit that is mounted on the fluorescent pipe and that reconverts an output from an electric conversion circuit inherent to the fluorescent lamp such as a stabilizer, a glow switch starter and an inverter and supplies the reconverted output to the LED.

In accordance with this arrangement, since the LED, the light scattering member and the reconversion circuit are integrally mounted on the fluorescent pipe, it is possible to put the fluorescent lamp compatible LED illuminating device into operation just by mounting this fluorescent lamp compatible LED illuminating device on a ready-made fluorescent lamp body without requiring a new adaptor or a new component.

In addition, if the fluorescent lamp compatible LED illuminating device uses the LED of a deep ultraviolet light irradiation type that irradiates the light having the wavelength generally the same as that of a mercury gas, a ready-made fluorescent pipe can be diverted to the fluorescent lamp compatible LED illuminating device as it is, so that it is possible to reduce a new development cost or a new manufacturing cost as much as possible.

Furthermore, in this invention, since a uniform electric field can be given to the semiconductor element body by the (front) surface electrode, it is possible to easily obtain a big light intensity by enabling the LED to make an ideal plane emission. Meanwhile, if the surface electrode is used, the surface electrode ordinarily blocks off the light so that the efficiency of taking the light outside is extremely aggravated. Contrarily, with this invention, since a plurality of dielectric antennas are arranged to penetrate the surface electrode, the light as being an electromagnetic wave is condensed into the dielectric antennas and emitted outside so that it is possible to largely reduce a shading effect on the electrode. More specifically, it is possible to enable ideal plane emission and to take the large light intensity generated by the plane emission to outside. Further, its efficiency becomes more than twice of a conventional fluorescent lamp. With this invention, since it is possible to reduce generation of heat with securing a light intensity necessary for a general illuminating device because of the high efficiency, there is no need of any heat dissipating member and it is possible to provide the fluorescent lamp compatible LED illuminating device that can replace a ready-made fluorescent pipe.

As a concrete configuration of the LED, it is preferable that the LED is mounted on both end parts of the fluorescent pipe in an orientation with its luminous surface orthogonal to a longitudinal direction of the fluorescent pipe. With this arrangement, since the fluorescent compatible LED illuminating device becomes a structure of rotational symmetry with a center on an axis of the fluorescent pipe, it is possible to make the whole surface of the fluorescent pipe shine preferably. As a result, the same illumination can be obtained even though the fluorescent pipe is mounted at any angle on the fluorescent lamp body.

Meanwhile, the LED may be arranged in the fluorescent pipe in an orientation with its luminous surface parallel to a longitudinal direction of the fluorescent pipe. With this arrangement, it is possible to enlarge a surface area of the LEDs and eventually to increase the luminous intensity more easily.

In order to make the entire fluorescent pipe shine by evenly irradiating the light from the LED on the fluorescent pipe, a floating light scattering particle that is enclosed in the fluorescent pipe may be used as the light scattering member.

In addition, another embodiment represented is that the light scattering member is a light guide of a lengthy shape that has a plurality of light scattering parts on its outer circumferential surface and that bridges over a gap between LEDs and into an inside of which the deep ultraviolet light or the ultraviolet light is introduced from both of its end surfaces of the light guide, and the deep ultraviolet light or the ultraviolet light that has been introduced into the light guide scatters at the light scattering part so as to be irradiated outward.

### EFFECT OF THE INVENTION

In accordance with this invention having the above-mentioned embodiment, it is possible to put the fluorescent lamp compatible LED illuminating device into operation without requiring a heat dissipating member just by mounting this fluorescent lamp compatible LED illuminating device on a ready-made fluorescent lamp body. In addition, since the LED irradiates the deep ultraviolet light or the ultraviolet light, a ready-made fluorescent pipe can be diverted as it is. As a result, it is possible to reduce a new development cost or a new manufacturing cost as much as possible. Furthermore, since the LED uses multiple dielectric antennas and a surface electrode, plane emission can be conducted with high efficiency. In addition, since the light is scattered by the light scattering member, it possible to make the entire fluorescent pipe shine.

### BRIEF DESCRIPTION OF THE DRAWINGS

FIG. 1 is a general view showing an internal structure of a fluorescent lamp compatible LED illuminating device in accordance with one embodiment of this invention.

FIG. 2 is a pattern cross-sectional view of a plane emission LED in accordance with this embodiment.

FIG. 3 is a pattern perspective view of the plane emission LED in accordance with this embodiment.

FIG. 4 is a pattern cross-sectional view of a plane emission LED in accordance with another embodiment of this invention.

FIG. 5 is a general view showing an internal structure of a fluorescent lamp compatible LED illuminating device in accordance with a further different embodiment of this invention.

FIG. 6 is a general view showing an internal structure of a fluorescent lamp compatible LED illuminating device in accordance with a further different embodiment of this invention.

### BEST MODES OF EMBODYING THE INVENTION

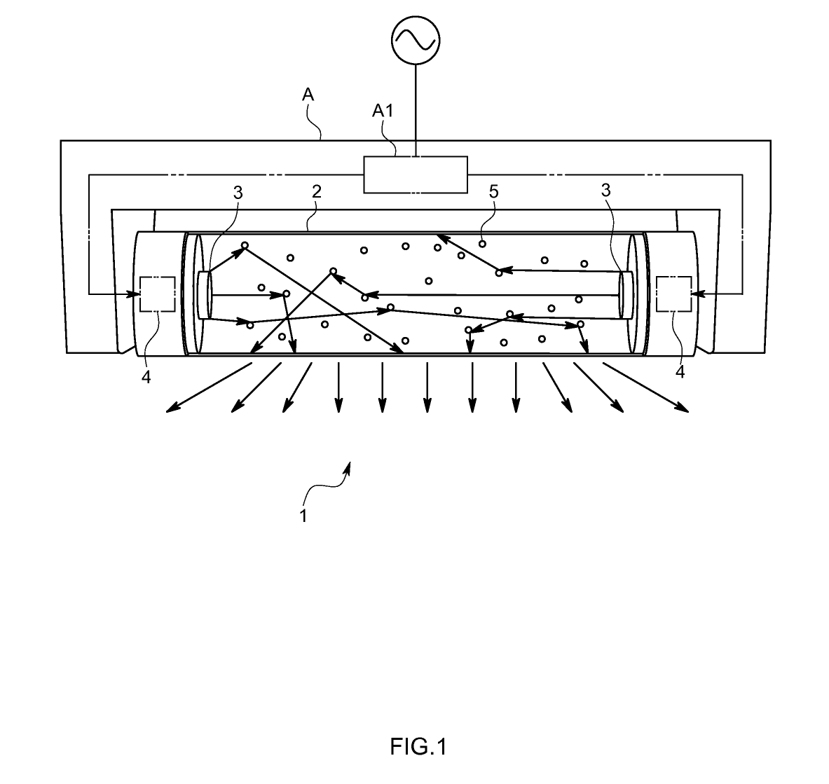

Embodiments of this invention will be explained with reference to FIG. 1 through FIG. 6.

A fluorescent lamp compatible LED illuminating device 1 in accordance with this embodiment comprises, as shown in FIG. 1, a glass fluorescent pipe 2 used for a fluorescent lamp, deep ultraviolet LEDs 3 of a plane emission type that are mounted on both end parts of the fluorescent pipe 2 with its luminous surfaces facing each other, namely in a orientation with its luminous surface orthogonal to a longitudinal direction of the fluorescent pipe 2, and a reconversion circuit 4 that supplies appropriate electric power to the LEDs 3, and a light scattering particle 5 that diffuses or scatters the light emitted from each LED 3.

Each component will be explained.

The fluorescent pipe 2 is of a cylindrical shape, made of glass to which a luminescence material is applied, and mounted on a ready-made fluorescent lamp body A.

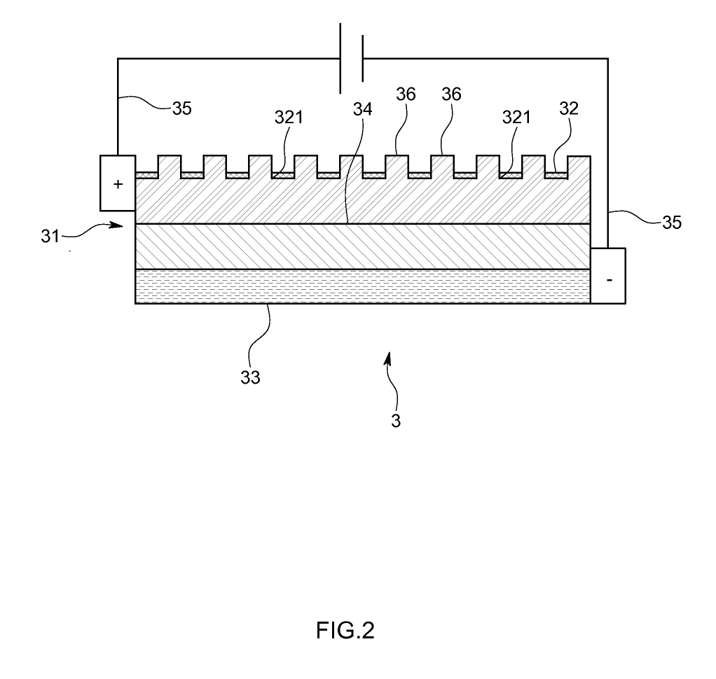

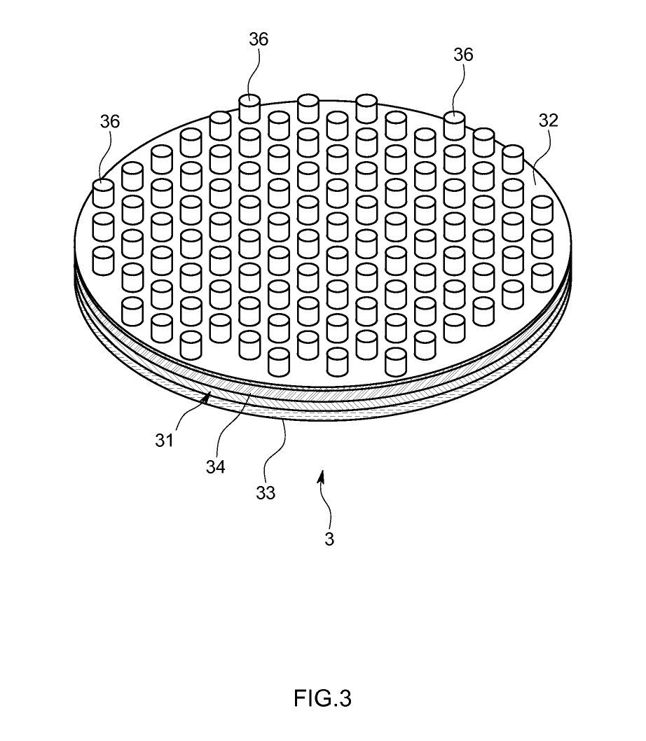

The LED 3 comprises, as shown in FIG. 2 and FIG. 3, a semiconductor element body 31 in a thin plate shape having a PN-junction structure, a surface electrode 32 arranged to generally cover a front surface of the semiconductor element body 31, and a reflecting plate also serving as a back surface electrode 33 arranged to generally cover a back surface of the semiconductor element body 31. The LED 3 emits deep ultraviolet light (about 50 nm˜about 300 nm, preferably a mercury wavelength (near 253.7 nm)) from a PN-junction layer 34 formed in the middle of the LED 3. A lead wire 35 for supplying electric power is connected to a peripheral part of the semiconductor element body 31.

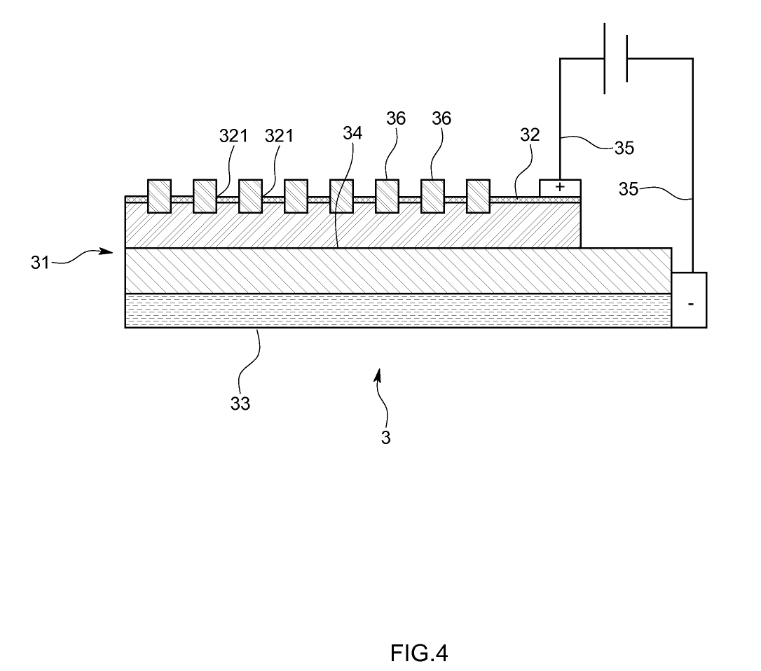

A plurality of through bores 321 are formed in a thickness direction at a certain pitch over generally the entire surface electrode 32. At each through bore 321 arranged is a dielectric antenna 36 of a size so that the deep ultraviolet light emitted from the semiconductor element body 31 is collected and transmitted. In order to effectively produce the function as the dielectric antenna 36 for the light, it is necessary for the dielectric antenna 36 to be a size such that both a height and a width (a diameter) are approximately from a fraction of the wavelength of the light to dozens of the wavelength of the light. More preferably, the size of the dielectric antenna 36 is approximately from one third to triple of the wavelength of the light. In addition, a shape of the dielectric antenna 36 is a cylinder in FIG. 2 and FIG. 3, however, it may be a polygonal column or an elliptic cylinder. Furthermore, the dielectric antenna 36 may be continuously and integrally formed with the semiconductor element body 31 or may be made of a member whose dielectric constant is different as shown in FIG. 4.

The reconversion circuit 4 reconverts an electric signal output from an electric conversion circuit A1 inherent to the fluorescent lamp such as a stabilizer, a glow switch starter, or an inverter to a preferable waveform, to drive the LED 3. More concretely, the reconversion circuit 4 contains a constant voltage circuit that reduces a high voltage applied from the electric conversion circuit A1 at a time of starting up the fluorescent lamp and that applies a subsequent stabilized voltage to the LED 3 as it is. The reconversion circuit 4 is mounted on, for example, a back surface of the board of the LED 3 and housed in both end parts of the fluorescent pipe 2 together with the LED 3.

The light scattering particle 5 is, for example, a very fine particle that moves around at random, making a Brownian movement while floating. The light scattering particle 5 is enclosed in the fluorescent pipe 2.

The fluorescent pipe 2 houses all of the LED 3, the reconversion circuit 4 and the light scattering particle 5 so that the fluorescent pipe 2 can be replaced by a ready-made fluorescent pipe. With this arrangement, it is possible to put the fluorescent lamp compatible LED illuminating device 1 into operation just by mounting this fluorescent lamp compatible LED illuminating device 1 on a ready-made fluorescent lamp body A without requiring a new adaptor or a new component.

In addition, since the fluorescent lamp compatible LED illuminating device 1 uses the LED 3 of the deep ultraviolet light irradiation type that irradiates the light having the wavelength generally the same as that of a mercury gas, a ready-made fluorescent pipe 2 can be diverted as it is. As a result, it is possible to reduce a new development cost or a new manufacturing cost as much as possible.

Furthermore, since a uniform electric field can be given to the semiconductor element body 31 by the front surface electrode and the back surface electrode that cover the front surface and the back surface of the semiconductor element body 31, it is possible to easily obtain a big light intensity by enabling ideal plane emission of the semiconductor element body 31. In addition, since a plurality of dielectric antennas 36 are arranged to penetrate the surface electrode 32 even though the surface electrode 32 covers the emitting area of the semiconductor element body 31, the light as being an electromagnetic wave is condensed into the dielectric antennas 36 and emitted outside. As a result, it is possible to largely reduce a shading effect on the electrode. More specifically, it is possible to enable ideal plane emission and to bring the large light intensity generated by the plane emission to outside. Its efficiency becomes more than twice that of a conventional fluorescent lamp. With this embodiment, since it is possible to reduce generation of heat with securing a light intensity necessary for a general illumination device because of high efficiency, it is possible to put the fluorescent lamp compatible LED illuminating device into operation without requiring any heat dissipating member. More specifically, it is possible to provide the LED illumination device 1 alternative to the fluorescent lamp.

Furthermore, since the light scattering particles are enclosed and floating in the fluorescent pipe 2, the light from the LED 3 scatters and is evenly irradiated on the fluorescent pipe 2, which enables the entire fluorescent pipe 2 to shine.

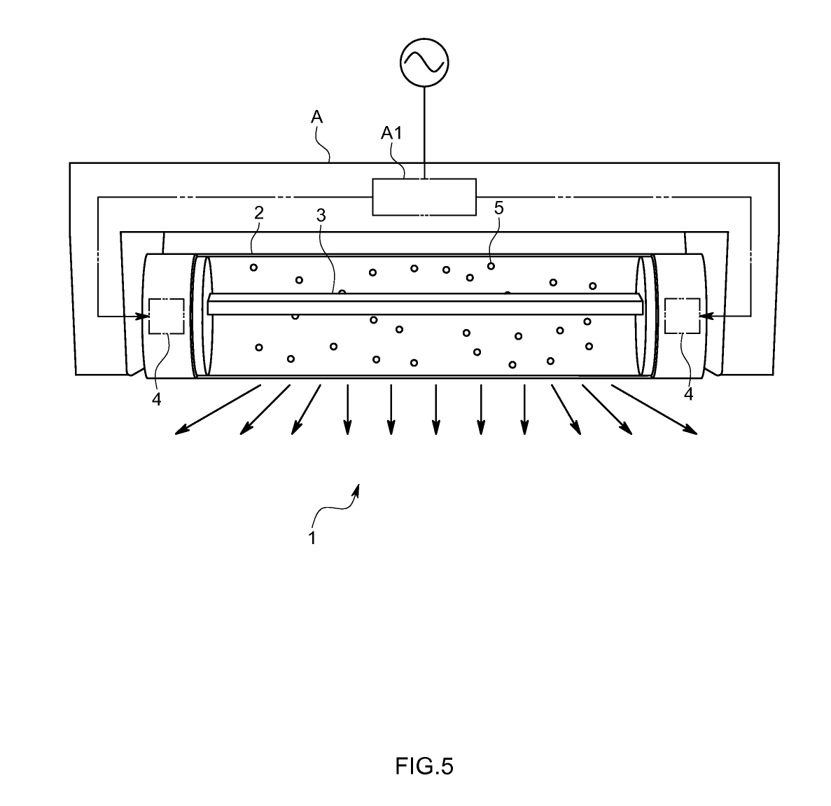

The present claimed invention is not limited to the above-mentioned embodiment. For example, as shown in FIG. 5, the LED 3 may be arranged in the fluorescent pipe 2 in a orientation with its luminous surface parallel to a longitudinal direction of the fluorescent pipe 2. Near-ultraviolet light of 300 nm or more may be used.

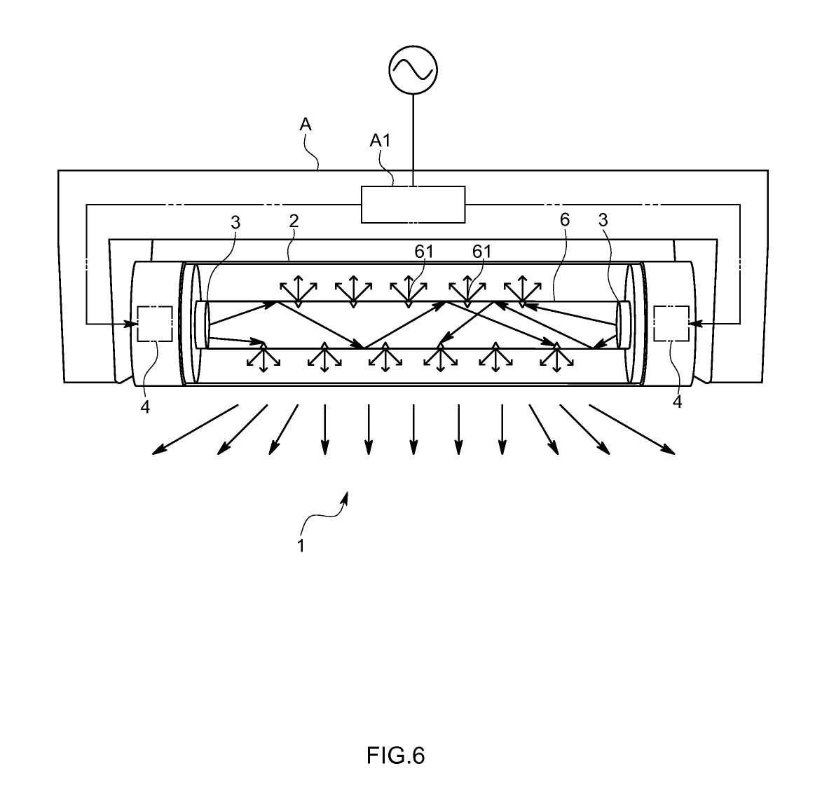

In addition, the light scattering member 5 may be, as shown in FIG. 6, a cylindrical light guide 6 that has multiple light scattering parts 61 on its outer circumferential surface, and that bridges over a gap between the LEDs 3 and into an inside of which the deep ultraviolet light or the ultraviolet light is introduced from both end surfaces thereof. With this arrangement, the deep ultraviolet light or the ultraviolet light introduced into an inside of the light guide 6 scatters at the light scattering parts 61 and is irradiated outside.

The present claimed invention is not limited to the above-mentioned illustrated examples or embodiments and may be variously modified without departing from the spirit of the invention.

### POSSIBLE APPLICATIONS IN INDUSTRY

In accordance with this invention having the above arrangement, it is possible to put the fluorescent lamp compatible LED illuminating device into operation without requiring any heat dissipating member just by mounting the fluorescent lamp compatible LED illuminating device on a ready-made fluorescent lamp body. In addition, since the LED irradiates deep ultraviolet light or ultraviolet light, the ready-made fluorescent pipe can be diverted as it is, so that a new development cost or a manufacturing cost can be reduced as much as possible. Furthermore, since the LED uses multiple dielectric antennas and the surface electrode, plane emission can be conducted with high efficiency. In addition, since the light is scattered by the light scattering member, it possible to make the entire fluorescent pipe shine.

1. A fluorescent lamp compatible LED illuminating device comprising
a glass fluorescent pipe used for a fluorescent lamp,
an LED that comprises a semiconductor element body that emits deep ultraviolet light or ultraviolet light from a PN-junction layer in a shape of a thin plate formed midway in a thickness direction thereof, a surface electrode arranged on a surface of the semiconductor element body and a dielectric antenna that is arranged intermittently over the surface electrode and penetrates its thickness direction and that collects and transmits the deep ultraviolet light or the ultraviolet light emitted from the semiconductor element body, and that is mounted on the fluorescent pipe so as to irradiate the deep ultraviolet light or the ultraviolet light toward an internal space of the fluorescent pipe,
a light scattering member that is housed or arranged in the fluorescent pipe and that diffuses or scatters light from the LED, and
a reconversion circuit that is mounted on the fluorescent pipe and that reconverts an output from an electric conversion circuit inherent to the fluorescent lamp and supplies the reconverted output to the LED.

2. The fluorescent lamp compatible LED illuminating device described in claim 1, wherein
the LED his mounted on both end parts of the fluorescent pipe in an orientation with its luminous surface orthogonal to a longitudinal direction of the fluorescent pipe.

3. The fluorescent lamp compatible LED illuminating device described in claim 1, wherein
the LED his arranged in the fluorescent pipe in an orientation with its luminous surface parallel to a longitudinal direction of the fluorescent pipe.

4. The fluorescent lamp compatible LED illuminating device described in claim 1, wherein
the light scattering member is a floating light scattering particle that is enclosed in the fluorescent pipe.

5. The fluorescent lamp compatible LED illuminating device described in claim 2, wherein
the LED is one of at least two LEDs, and
the light scattering member his a light guide of a lengthy shape that has a plurality of light scattering parts on its outer circumferential surface and that bridges over a gap between the LEDs and into an inside of which the deep ultraviolet light or the ultraviolet light is introduced from both of its end surfaces of the light guide, and the deep ultraviolet light or the ultraviolet light that has been introduced into the light guide scatters at each of the plurality of light scattering parts so as to be irradiated outward.

6. The fluorescent lamp compatible LED illuminating device described in claim 1, wherein the electric conversion circuit is selected from the group comprising a stabilizer, a glow switch starter and an inverter.
